(19) United States
(12) Patent Application Publication
(10) Pub. No.: US 2023/0214444 A1
(43) Pub. Date: Jul. 6, 2023

(54) QUANTUM CIRCUIT FOR DAUBECHIES-6 (D6) WAVELET TRANSFORM AND INVERSE TRANSFORM AND MANUFACTURING METHOD THEREOF

(71) Applicant: NATIONAL CHENG KUNG UNIVERSITY, Tainan City (TW)

(72) Inventor: Chi-Chuan HWANG, Tainan City (TW)

(73) Assignee: NATIONAL CHENG KUNG UNIVERSITY, Tainan City (TW)

(21) Appl. No.: 17/738,944

(22) Filed: May 6, 2022

(30) Foreign Application Priority Data
Jan. 4, 2022 (TW) 111100519

(51) Int. Cl. G06F 17/14; G06N 10/40

(52) U.S. Cl. CPC G06F 17/148; G06N 10/40

(57) ABSTRACT

A quantum circuit for Daubechies-6 wavelet transform includes: a B quantum circuit configured to receive a first part of n-dimensional data and generate a first intermediate result; a Q₂_{ⁿ}·Q₂_{ⁿ} quantum circuit configured to receive a second part of the n-dimensional data, and the Q₂_{ⁿ}·Q₂_{ⁿ} quantum circuit coupled to the B quantum circuit to receive the first intermediate result, and the Q₂_{ⁿ}·Q₂_{ⁿ} quantum circuit generating a second intermediate result corresponding to the first intermediate result and a first result corresponding to the second part; and an A quantum circuit coupled to the Q₂_{ⁿ}·Q₂_{ⁿ} quantum circuit to receive the second intermediate result and to generate a second result according to the second intermediate result. The present disclosure further discloses a manufacturing method of a quantum circuit for Daubechies-6 wavelet transform and a quantum circuit for Daubechies-6 wavelet inverse transform corresponding to the aforementioned quantum circuit for Daubechies-6 wavelet transform.

### CROSS-REFERENCE TO RELATED APPLICATIONS

This non-provisional application claims priority under 35 U.S.C. § 119(a) on Patent Application No(s). 111100519 filed in Taiwan on Jan. 4, 2022, the entire contents of which are hereby incorporated by reference.

### BACKGROUND

### 1. Technical Field

This disclosure relates to a quantum circuit and a manufacturing method thereof, and particularly relates to a quantum circuit for Daubechies-6 (D6) wavelet transform and inverse transform and a manufacturing method thereof using Daubechies-6 (D6) wavelet transform and inverse transform.

### 2. Related Art

Since Moore, who is one of founders of Intel Corporation, found that the number of transistors integrated on one chip doubled approximately every two years, this find has been proved repeatedly in the history of chip development in the following decades and this is also known as Moore's Law in computer and semiconductor industries. However, as the integration density of transistors continuously increases, problems about power consumption and heat dissipation of chips, manufacturing of chips, etc. cause that the conventional silicon chip computers encounter the development limit, and Moore's law will also fail because of the physical limit. Hereby, related industries have tried to introduce quantum motion of particles at the microscopic scale and process information by the way of quantum bits, and this is the so-called quantum computer. The quantum computer is generally expected to develop rapidly as the silicon chip computers encounter the limit.

On the other hand, the conventional wavelet package transform has been widely used in a field of information processing, and particularly, Haar wavelet package transformation and Daubechies wavelet package transform are two pieces of important conventional wavelet package transformation. The Daubechies wavelet package transform may be classified into Daubechies wavelets such as D2, D4, D6, D8, etc., according to different filter lengths, while the Haar wavelet package transform is the simplest one of wavelet package transformation and is equivalent to D2 Daubechies wavelet package transform.

In other words, to overcome the limit problem which the conventional silicon chip computer faces, it is needed to find a solution to apply Daubechies wavelet package transform to the field of quantum information to extend to Daubechies wavelet transform, and the quantum circuit for Daubechies-6 (D6) wavelet transform corresponding to quanta with higher resolution greater than D6 should be manufactured to meet the needs of high information complexity in the current information field.

### SUMMARY

In light of the above description, an objective of the present disclosure is to decrease the dimension of the Daubechies-6 (D6) wavelet matrix with the high dimension and complicated coefficient relationship to be related to 4×4 of matrix complexity to achieve a quantum circuit for Daubechies-6 (D6) wavelet transform.

According to one or more embodiment of this disclosure, a quantum circuit for Daubechies-6 (D6) wavelet transform includes a B quantum circuit, a Q₂_{ⁿ}·Q₂_{ⁿ} quantum circuit and an A quantum circuit. The B quantum circuit is configured to receive a first part of n-dimensional data and generate a first intermediate result, wherein the first part includes data of (n−1)th dimension and data of nth dimension of the n-dimensional data. The Q₂_{ⁿ}·Q₂_{ⁿ} quantum circuit is configured to receive a second part of the n-dimensional data, the Q₂_{ⁿ}·Q₂_{ⁿ} quantum circuit is coupled to the B quantum circuit to receive the first intermediate result, and the Q₂_{ⁿ}·Q₂_{ⁿ} quantum circuit generates a second intermediate result corresponding to the first intermediate result and a first result corresponding to the second part, wherein the second part includes data of 1st dimension to data of (n−2)th dimension of the n-dimensional data. The A quantum circuit is coupled to the Q₂_{ⁿ}·Q₂_{ⁿ} quantum circuit to receive the second intermediate result and to generate a second result according to the second intermediate result. The B quantum circuit and the A quantum circuit are configured to implement two 4×4 parameter matrixes, the Q₂_{ⁿ}·Q₂_{ⁿ} quantum circuit is configured to implement an dot product of the two same 2ⁿ×2ⁿ unitary matrixes configured to transfer a state amplitude, the n is positive integer and a set of the first result and the second result serves an output of the quantum circuit for Daubechies-6 (D6) wavelet transform.

According to one or more embodiment of this disclosure, a quantum circuit for Daubechies-6 (D6) wavelet inverse transform includes a (A)⁻¹ quantum circuit, a (Q₂_{ⁿ})⁻¹·(Q₂_{ⁿ})⁻¹ quantum circuit and a (B)⁻¹ quantum circuit. The (A)⁻¹ quantum circuit is configured to receive a first part of n-dimensional data and generate a first intermediate result, wherein the first part includes data of (n−1)th dimension and data of nth dimension of the n-dimensional data. The (Q₂_{ⁿ})⁻¹·(Q₂_{ⁿ})⁻¹ quantum circuit is configured to receive a second part of n-dimensional data, the (Q₂_{ⁿ})⁻¹·(Q₂_{ⁿ})⁻¹ quantum circuit is coupled to the (A)⁻¹ quantum circuit to receive the first intermediate result, and the (Q₂_{ⁿ})⁻¹·(Q₂_{ⁿ})⁻¹ quantum circuit generates a second intermediate result corresponding to the first intermediate result and a first result corresponding to the second part, wherein the second part includes data of 1st dimension to data of (n−2)th dimension of the n-dimensional data. The (B)⁻¹ quantum circuit is coupled to the (Q₂_{ⁿ})⁻¹·(Q₂_{ⁿ})⁻¹ quantum circuit to receive the second intermediate result and to generate a second result according to the second intermediate result. The (A)⁻¹ quantum circuit and the (B)⁻¹ quantum circuit are configured to achieve inverse matrixes of two 4×4 parameter matrixes, the (Q₂_{ⁿ})⁻¹·(Q₂_{ⁿ})⁻¹ quantum circuit is configured to implement an dot product of inverse matrixes of the two same 2ⁿ×2ⁿ unitary matrixes and the two same 2ⁿ×2ⁿ unitary matrixes configured to transfer a state amplitude, the n is positive integer and a set of the first result and the second result serves an output of the quantum circuit for Daubechies-6 (D6) wavelet inverse transform.

In addition to the aforementioned quantum circuit for Daubechies-6 (D6) wavelet transform/inverse transform, according to one or more embodiment of this disclosure, a manufacturing method of a quantum circuit for Daubechies-6 (D6) wavelet transform including: decomposing a matrix D₂_{ⁿ}⁽⁶⁾ of Daubechies-6 (D6) wavelet into (I₂_{^{n−2}}⊗A) Q₂_{ⁿ}·Q₂_{ⁿ}·(I₂_{^{n−2}}⊗B); decomposing the A into (U_{A1}⊗U_{A2})·M·(Aₐ₁⊕Aₐ₂)·M^{†}·(V_{A1}⊗V_{A2}) , and decomposing the B into (B_{B1}⊗U_{B2})·M·(B_{b1}⊕B_{b2})·M^{†}·(V_{B1}⊗V_{B2}); constituting the quantum circuit for Daubechies-6 (D6) wavelet transform by a plurality of basic 1-bit logic gates, a controlled-NOT gate and a controlled-U gate based on (I₂_{^{n−2}}⊗A)·Q₂_{ⁿ}·Q₂_{ⁿ}·(I₂_{^{n−2}}⊗B), (U_{A1}⊗U_{A2})·M·(Aₐ₁⊕Aₐ₂)·M^{†}·(V_{A1}⊗V_{A2}) and (U_{B1}⊗U_{B2})·M·(B_{b1}⊕B_{b2})·M^{†}·(V_{B1}⊗V_{B2}). In the aforementioned content, the Aₐ₂ is

$$P h ( π ) \cdot {R}_{z} ( \frac{π}{2} ) \cdot {R}_{y} ( - 0.15909 π ) \cdot {R}_{z} ( \frac{3 π}{2} ) ,$$

### the U_{A1} is

$$Ph ( - 0.28355 π ) \cdot {R}_{z} ( - \frac{3 π}{2} ) \cdot {R}_{y} ( - \frac{3 π}{2} ) \cdot {R}_{z} ( \frac{3 π}{2} ) ,$$

### the U_{A2} is

$$P h ( - 0.71644 π ) \cdot {R}_{z} ( - \frac{3 π}{2} ) \cdot {R}_{y} ( - \frac{3 π}{2} ) \cdot {R}_{z} ( - 1.93289 π ) ,$$

### the V_{A1} is

$$Ph ( - \frac{π}{2} ) \cdot {R}_{z} ( - 1.15912 π ) \cdot {R}_{y} ( - \frac{π}{2} ) \cdot {R}_{z} ( - \frac{3 π}{2} ) ,$$

### the V_{A2} is

$$Ph ( - \frac{π}{2} ) \cdot {R}_{z} ( - \frac{3 π}{2} ) \cdot {R}_{y} ( - \frac{π}{2} ) \cdot {R}_{z} ( - \frac{3 π}{2} ) ,$$

### the B_{b1} is

$$Ph ( π ) \cdot {R}_{z} ( - \frac{π}{2} ) \cdot {R}_{y} ( 1.15909 π ) \cdot {R}_{z} ( \frac{π}{2} ) ,$$

### the B_{b2} is

$$P h ( π ) \cdot {R}_{z} ( - \frac{π}{2} ) \cdot {R}_{y} ( - 0.15909 π ) \cdot {R}_{z} ( - \frac{3 π}{2} ) ,$$

### the U_{B1} is Ph(π)·

$${R}_{z} ( - \frac{3 π}{2} ) \cdot {R}_{y} ( - \frac{π}{2} ) \cdot {R}_{z} ( - 1.84088 π ) ,$$

### the U_{B2} is

$$Ph ( π ) \cdot {R}_{z} ( - \frac{3 π}{2} ) \cdot {R}_{y} ( - \frac{π}{2} ) \cdot {R}_{z} ( - \frac{π}{2} ) ,$$

### the V_{B1} is

$$P h ( - 0.12552 π ) \cdot {R}_{z} ( - \frac{3 π}{2} ) \cdot {R}_{y} ( - \frac{π}{2} ) \cdot {R}_{z} ( - \frac{3 π}{2} ) ,$$

### the V_{B2} is

$$Ph ( - 0.874471 π ) \cdot {R}_{z} ( - 1.24894 π ) \cdot {R}_{y} ( - \frac{3 π}{2} ) \cdot {R}_{z} ( - \frac{π}{2} ) ,$$

### the M is

$$\frac{1}{\sqrt{2}} [ \begin{matrix}1 & 0 & 0 & i \\ 0 & i & 1 & 0 \\ 0 & i & - 1 & 0 \\ 1 & 0 & 0 & - i\end{matrix} ] ,$$

the M^{†} is a conjugate transpose matrix of the M, and the 2ⁿ×2ⁿ unitary matrix is

$$[ \begin{matrix}0 & 1 & 0 & 0 & … & 0 \\ 0 & 0 & 1 & 0 & … & 0 \\ 0 & 0 & 0 & 1 & … & 0 \\ ⋮ & ⋮ & ⋮ & ⋮ & ⋱ & 0 \\ 0 & 0 & 0 & 0 & … & 1 \\ 0 & 0 & 0 & 0 & … & 0\end{matrix} ] .$$

### BRIEF DESCRIPTION OF THE DRAWINGS

FIG. 1A to FIG. 1I illustrate element symbol diagrams of basic 1-bit logic gates being usable for the quantum circuit for Daubechies-6 (D6) wavelet transform according to one embodiment of the present disclosure.

FIG. 2A illustrates a schematic diagram of a controlled-NOT gate being usable for the quantum circuit for Daubechies-6 (D6) wavelet transform according to one embodiment of the present disclosure.

FIG. 2B illustrates a schematic diagram of a controlled-U gate being usable for the quantum circuit for Daubechies-6 (D6) wavelet transform according to one embodiment of the present disclosure.

FIG. 3A illustrates a circuit diagram of the quantum circuit for Daubechies-6 (D6) wavelet transform according to one embodiment of the present disclosure.

FIG. 3B illustrates a circuit diagram of the A quantum circuit in the quantum circuit for Daubechies-6 (D6) wavelet transform according to the embodiment illustrated in FIG. 3A.

FIG. 3C illustrates a circuit diagram of the B quantum circuit in the quantum circuit for Daubechies-6 (D6) wavelet transform according to the embodiment illustrated in FIG. 3A.

FIG. 3D illustrates a circuit diagram of the Q₂_{ⁿ}·Q₂_{ⁿ} quantum circuit in the quantum circuit for Daubechies-6 (D6) wavelet transform according to the embodiment illustrated in FIG. 3A.

FIG. 4A illustrates a circuit diagram of the M quantum circuit in the quantum circuit for Daubechies-6 (D6) wavelet transform according to the embodiment illustrated in FIG. 3B or FIG. 3C.

FIG. 4B illustrates a circuit diagram of the Mt quantum circuit in the quantum circuit for Daubechies-6 (D6) wavelet transform according to the embodiment illustrated in FIG. 3B or FIG. 3C.

FIG. 4C to FIG. 4H illustrate circuit diagrams of Aₐ₁, Aₐ₂, U_{A1}, U_{A2}, V_{A1}, V_{A2} in the quantum circuit for Daubechies-6 (D6) wavelet transform according to the embodiment illustrated in FIG. 3B.

FIG. 4I to FIG. 4N illustrate circuit diagrams of B_{b1}, B_{b2}, U_{B1}, U_{B2}, V_{B1}, V_{B2} in the quantum circuit for Daubechies-6 (D6) wavelet transform according to the embodiment illustrated in FIG. 3C.

FIG. 5A illustrates a circuit diagram of the quantum circuit for Daubechies-6 (D6) wavelet inverse transform according to one embodiment of the present disclosure.

FIG. 5B illustrates a circuit diagram of the (A)⁻¹ quantum circuit in the quantum circuit for Daubechies-6 (D6) wavelet inverse transform according to the embodiment illustrated in FIG. 5A.

FIG. 5C illustrates a circuit diagram of the (B)⁻¹ quantum circuit in the quantum circuit for Daubechies-6 (D6) wavelet inverse transform according to the embodiment illustrated in FIG. 5A.

FIG. SD illustrates a circuit diagram of the (Q₂_{ⁿ})⁻¹·(Q₂_{ⁿ})⁻¹ quantum circuit in the quantum circuit for Daubechies-6 (D6) wavelet inverse transform according to the embodiment illustrated in FIG. 5A.

FIG. 6 illustrates a flowchart of the manufacturing method of the quantum circuit for Daubechies-6 (D6) wavelet transform according to one embodiment of the present disclosure.

### DETAILED DESCRIPTION

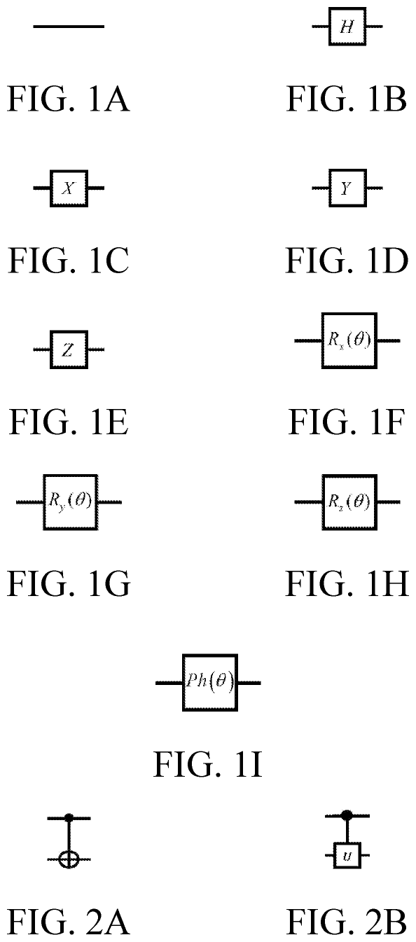

The present disclosure sets forth the quantum circuit for Daubechies-6 (D6) wavelet transform and inverse transform based on the Daubechies-6 (D6) wavelet matrix. The quantum circuit indicates to include a combination of basic 1-bit logic gates (usually denoted as a 2×2 matrix), a controlled-NOT gate and a controlled-U gate, but is not limited thereto. In order to explain the aforementioned basic 1-bit logic gates, the controlled-NOT gate and the controlled-U gate to more clearly explain the quantum circuit for Daubechies-6 (D6) wavelet transform and inverse transform according to one embodiment of the present disclosure, please refer to FIG. 1A to FIG. 1I, FIG. 2A and FIG. 2B. Specifically, FIG. 1A to FIG. 1H sequentially illustrates an identity gate, a Hadamard gate, a Pauli-X gate, a Pauli-Y gate, a Pauli-Z gate, a Rotation-X gate, a Rotation-Y gate, a Rotation-Z gate and a Phase-Shift gate each of which is a basic 1-bit logic gate. Besides, FIG. 2A illustrates the controlled-NOT gate and FIG. 2B illustrates the controlled-U gate.

The Daubechies-6 (D6) wavelet matrix D₂_{ⁿ}⁽⁶⁾ in the present embodiment is usually expressed as:

$${D}_{{2}^{n}}^{( 6 )} = [ \begin{matrix}{c}_{0} & {c}_{1} & {c}_{2} & {c}_{3} & {c}_{4} & {c}_{5} & 0 & 0 & … & 0 & 0 & 0 & 0 & 0 & 0 \\ {c}_{5} & - {c}_{4} & {c}_{3} & - {c}_{2} & {c}_{1} & - {c}_{0} & 0 & 0 & … & 0 & 0 & 0 & 0 & 0 & 0 \\ 0 & 0 & {c}_{0} & {c}_{1} & {c}_{2} & {c}_{3} & {c}_{4} & {c}_{5} & … & 0 & 0 & 0 & 0 & 0 & 0 \\ 0 & 0 & {c}_{5} & - {c}_{4} & {c}_{3} & - {c}_{2} & {c}_{1} & - {c}_{0} & … & 0 & 0 & 0 & 0 & 0 & 0 \\ ⋮ & ⋮ & ⋮ & ⋮ & ⋮ & ⋮ & ⋮ & ⋮ & ⋱ & 0 & 0 & 0 & 0 & 0 & 0 \\ 0 & 0 & 0 & 0 & 0 & 0 & 0 & 0 & … & {c}_{0} & {c}_{1} & {c}_{2} & {c}_{3} & {c}_{4} & {c}_{5} \\ 0 & 0 & 0 & 0 & 0 & 0 & 0 & 0 & … & {c}_{5} & - {c}_{4} & {c}_{3} & - {c}_{2} & {c}_{1} & - {c}_{0} \\ {c}_{4} & {c}_{5} & 0 & 0 & 0 & 0 & 0 & 0 & … & 0 & 0 & {c}_{0} & {c}_{1} & {c}_{2} & {c}_{3} \\ {c}_{1} & - {c}_{0} & 0 & 0 & 0 & 0 & 0 & 0 & … & 0 & 0 & {c}_{5} & - {c}_{4} & {c}_{3} & - {c}_{2} \\ {c}_{2} & {c}_{3} & {c}_{4} & {c}_{5} & 0 & 0 & 0 & 0 & … & 0 & 0 & 0 & 0 & {c}_{0} & {c}_{1} \\ {c}_{3} & - {c}_{2} & {c}_{1} & - {c}_{0} & 0 & 0 & 0 & 0 & … & 0 & 0 & 0 & 0 & {c}_{5} & - {c}_{4}\end{matrix} ] ,$$

wherein the parameters c₀ to c₅ are as follows:

$${c}_{0} = \frac{\sqrt{2}}{32} ( 1 + \sqrt{10} + \sqrt{5 + 2 \sqrt{10}} ) \approx 0.332671 ;$$

$${c}_{1} = \frac{\sqrt{2}}{32} ( 5 + \sqrt{10} + 3 \sqrt{5 + 2 \sqrt{10}} ) \approx 0.8068 \; 92 ;$$

$${c}_{2} = \frac{\sqrt{2}}{32} ( 10 - 2 \sqrt{10} + 2 \sqrt{5 + 2 \sqrt{10}} ) \approx 0.4598 \; 78 ;$$

$${c}_{3} = \frac{\sqrt{2}}{32} ( 10 - 2 \sqrt{10} - 2 \sqrt{5 + 2 \sqrt{10}} ) \approx - 0.1350 \; 11 ;$$

$${c}_{4} = \frac{\sqrt{2}}{32} ( 5 + \sqrt{10} - 3 \sqrt{5 + 2 \sqrt{10}} ) \approx - 0 \text{.085441} ;$$

and

$${c}_{5} = \frac{\sqrt{2}}{32} ( 1 + \sqrt{10} - \sqrt{5 + 2 \sqrt{10}} ) \approx 0.035226 .$$

Based on matrix calculation, the aforementioned matrix D₂_{ⁿ}⁽⁶⁾ may be further decomposed into: (I₂_{^{n−2}}⊗A)·Q₂_{ⁿ}·Q₂_{ⁿ}·(I₂_{^{n−2}}⊗B). Thereby, the dimension of the Daubechies-6 (D6) wavelet matrix with the high dimension and complex coefficient relationship may be decreased to generate two parameter matrixes A, B merely involving 4×4 matrix complexity to facilitate the achievement of the quantum circuit for Daubechies-6 (D6) wavelet transform. In the aforementioned formula, I₂_{^{n−2}} is a unit matrix of 2ⁿ⁻²×2ⁿ⁻²; ⊗ is an operator of direct product; Q₂_{ⁿ} is a 2ⁿ×2ⁿ unitary matrix for transferring a state amplitude as follows:

$${Q}_{{2}^{n}} = [ \begin{matrix}0 & 1 & 0 & 0 & … & 0 \\ 0 & 0 & 1 & 0 & … & 0 \\ 0 & 0 & 0 & 1 & … & 0 \\ ⋮ & ⋮ & ⋮ & ⋮ & ⋱ & 0 \\ 0 & 0 & 0 & 0 & … & 1 \\ 0 & 0 & 0 & 0 & … & 0\end{matrix} ] ;$$

and the parameter matrix A and the parameter matrix B are obtained as follows by the way of simultaneous equations:

$$A = [ \begin{matrix}- 0.9944 & - 0.0505 & 0 & - 0.0924 \\ - 0.1053 & 0.4766 & 0 & 0.8728 \\ 0 & - 0.8728 & - 0.1053 & 0.4766 \\ 0 & - 0.0924 & 0.9944 & 0.0505\end{matrix} ]$$

and

$$B = [ \begin{matrix}- 0.1827 & - 0.4431 & 0.8114 & - 0.3345 \\ 0.9245 & - 0.3812 & 0 & 0 \\ - 0.3345 & - 0.8114 & - 0.4431 & 0.1827 \\ 0 & 0 & - 0.3812 & - 0.9245\end{matrix} ]$$

Besides, the aforementioned parameter matrix A and the parameter matrix B may be further decomposed as: A=(U_{A1}⊗U_{A2})·M·(Aₐ₁⊕Aₐ₂)·M^{†·(V}_{A1}⊗V_{A2}); B=(U_{B1}⊗U_{B2})·M·(B_{b1}⊕B_{b2})·M^{†}·(V_{B1}⊗V_{B2}), so as to apply two parameter matrixes to the quantum circuit. In the equations associated with the parameter matrix A and the parameter matrix B, ⊕ is an operator of direct sum; U_{A1}, U_{A2}, Aₐ₁, Aₐ₂, V_{A1}, V_{A2}, U_{B1}, U_{B2}, B_{b1}, B_{b2}, V_{B1} and V_{B2} are all 2×2 unitary matrixes to provide 1-bit logic gate to apply to the quantum circuit; M is a magic basis, and M^{†} is a conjugate transpose matrix of the magic basis, that is, M^{†}=(M)⁻¹, wherein the matrix form of the M and the M^{†} is expressed as follows:

$$M = \frac{1}{\sqrt{2}} [ \begin{matrix}1 & 0 & 0 & i \\ 0 & i & 1 & 0 \\ 0 & i & - 1 & 0 \\ 1 & 0 & 0 & - i\end{matrix} ] ; {M}^{†} = \frac{1}{\sqrt{2}} [ \begin{matrix}1 & 0 & 0 & 1 \\ 0 & - i & - i & 0 \\ 0 & 1 & - 1 & 0 \\ - i & 0 & 0 & i\end{matrix} ]$$

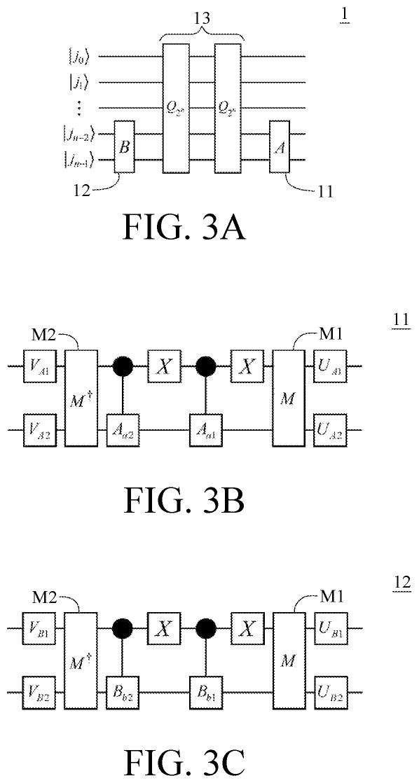

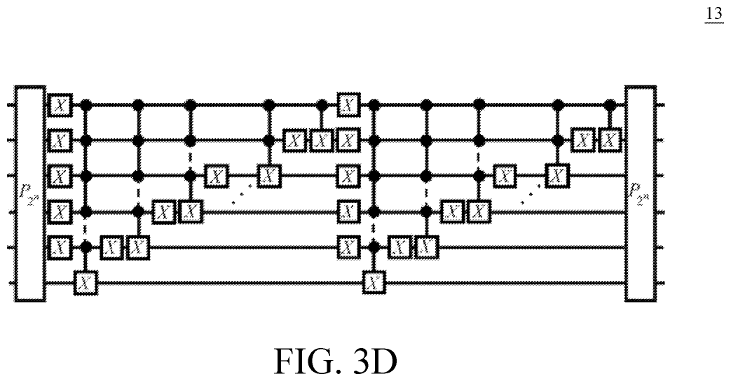

According to the decomposed Daubechies-6 (D6) wavelet matrix D₂_{ⁿ}⁽⁶⁾ (i.e., the aforementioned (I₂_{^{n−2}}⊗A)·Q₂_{ⁿ}·Q₂_{ⁿ}·(I₂_{^{n−2}}⊗B)), the quantum circuit 1 for Daubechies-6 (D6) wavelet transform in the present embodiment may be obtained as illustrated in FIG. 3A. In FIG. 3A, the A quantum circuit 11 configured to implement the parameter matrix A in one embodiment of the present disclosure may be illustrated in FIG. 3B, the B quantum circuit 12 configured to implement the parameter matrix B may be illustrated in FIG. 3C, the Q₂_{ⁿ}·Q₂_{ⁿ} quantum circuit 13 configured to implement a dot product of the unitary matrix Q₂_{ⁿ}, and the unitary matrix Q₂_{ⁿ} (i.e., Q₂_{ⁿ}·Q₂_{ⁿ}) may be illustrated in FIG. 3D. In the quantum circuit 1 for Daubechies-6 (D6) wavelet transform of the present embodiment, the B quantum circuit 12 is coupled to one side of the Q₂_{ⁿ}·Q₂_{ⁿ} quantum circuit 13 and the A quantum circuit 11 is coupled to the other side of the Q₂_{ⁿ}·Q₂_{ⁿ} quantum circuit 13. In operation, the quantum circuit 1 for Daubechies-6 (D6) wavelet transform of this embodiment is configured to receive n-dimensional data, wherein each dimension includes a 2×1 vector. In the aforementioned received n-dimensional data, the data of the 1st dimension to the data of the (n−2)th dimension which may correspond to j₀ as illustrated in FIG. 3A to jₙ₋₃ not illustrated in FIG. 3A are input into the Q₂_{ⁿ}·Q₂_{ⁿ} quantum circuit 13, and after the data of the (n−1)th dimension and the data of the nth dimension which may correspond to jₙ₋₂ and jₙ₋₁ as illustrated in FIG. 3A are input into the B quantum circuit 12, the operation result (denoted as the first intermediate result hereinafter) of the B quantum circuit 12 is input to the Q₂_{ⁿ}·Q₂_{ⁿ} quantum circuit 13. Afterwards, the first operation result to the (n−2)th operation result (called the first result) generated by the Q₂_{ⁿ}·Q₂_{ⁿ} quantum circuit 13 serve one part of output of the quantum circuit 1 for Daubechies-6 (D6) wavelet transform; and the (n−1)th operation result to the nth operation result (denoted as the second intermediate result hereinafter) corresponding to the first intermediate result generated by the Q₂_{ⁿ}·Q₂_{ⁿ} quantum circuit 13 are input to the A quantum circuit 11. The operation result (called the second result) generated by the A quantum circuit 11 according to the second intermediate result serves as the other part of output of the quantum circuit 1 for Daubechies-6 (D6) wavelet transform.

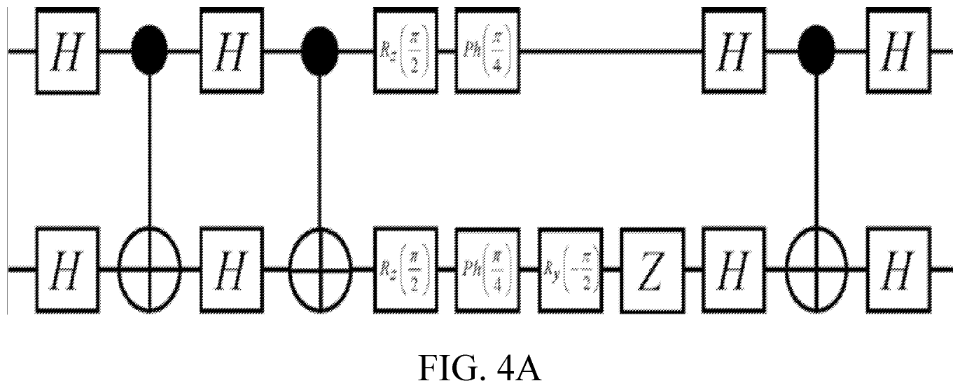

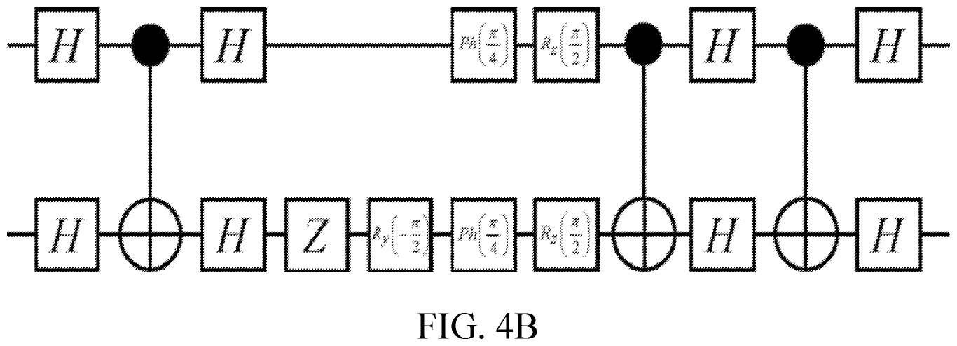

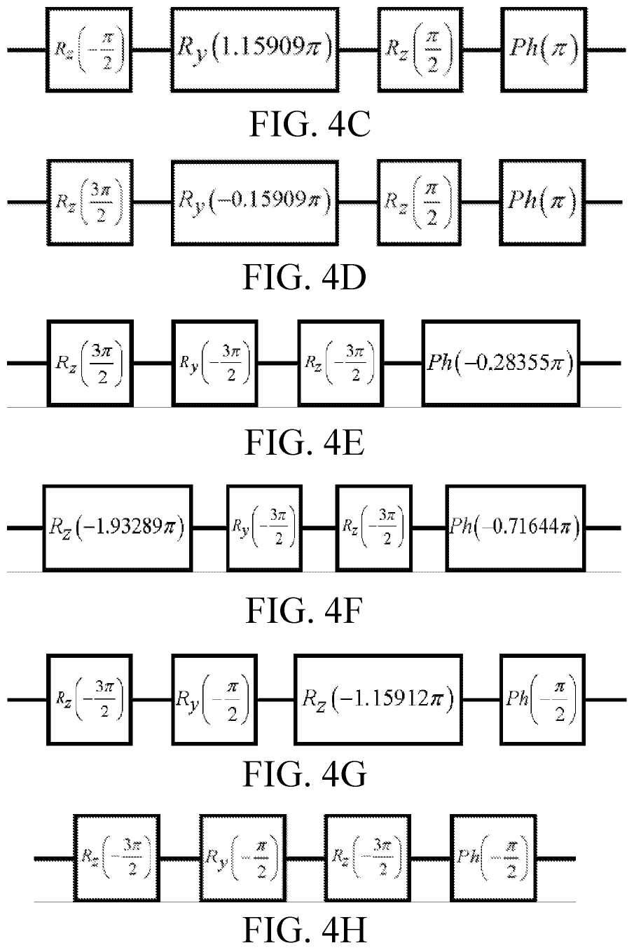

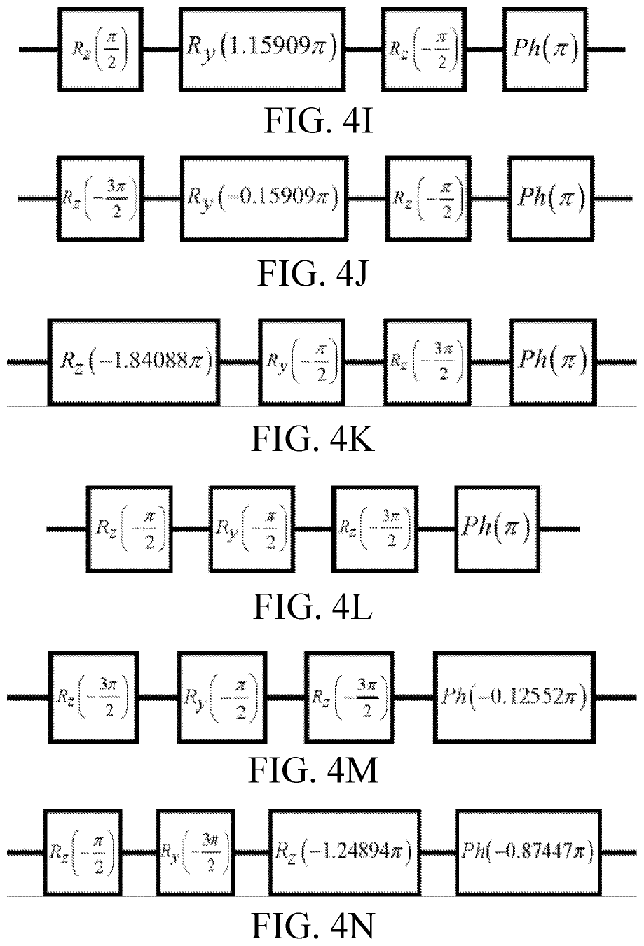

Specifically, a M quantum circuit M1 of the magic basis M in the A quantum circuit 11 is illustrated in FIG. 4A and a M^{†} quantum circuit M2 of the conjugate transpose matrix M^{†} of the magic basis M is illustrated in FIG. 4B. Aₐ₁, Aₐ₂, U_{A1}, U_{A2}, U_{A2}, V_{A1}, V_{A2} in the A quantum circuit 11 are respectively expressed as:

$${A}_{a 1} = {R}_{z} ( \frac{π}{2} ) \cdot {R}_{y} ( 1.15909 π ) \cdot {R}_{z} ( - \frac{π}{2} ) ;$$

$${A}_{a 2} = P h ( π ) \cdot {R}_{z} ( \frac{π}{2} ) \cdot {R}_{y} ( - 0.15909 π ) \cdot {R}_{z} ( \frac{3 π}{2} ) ;$$

$${U}_{A 1} = P h ( - 0.28355 π ) \cdot {R}_{z} ( - \frac{3 π}{2} ) \cdot {R}_{y} ( - \frac{3 π}{2} ) \cdot {R}_{z} ( \frac{3 π}{2} ) ;$$

$${U}_{A 2} = P h ( - 0.71644 π ) \cdot {R}_{z} ( - \frac{3 π}{2} ) \cdot {R}_{y} ( - \frac{3 π}{2} ) \cdot {R}_{z} ( - 1.93289 π ) ;$$

$${V}_{A 1} = Ph ( - \frac{π}{2} ) \cdot {R}_{z} ( - 1.15912 π ) \cdot {R}_{y} ( - \frac{π}{2} ) \cdot {R}_{z} ( - \frac{3 π}{2} ) ;$$

$${V}_{A 2} = ( - \frac{π}{2} ) \cdot {R}_{z} ( - \frac{3 π}{2} ) \cdot {R}_{y} ( - \frac{π}{2} ) \cdot {R}_{z} ( - \frac{3 π}{2} ) ,$$

and Aₐ₁, Aₐ₂, U_{A1}, U_{A2}, V_{A1}, V_{A2} in the A quantum circuit 11 may be respectively implemented by the basic 1-bit logic gates as illustrated in FIG. 4C to FIG. 4H. Similarly, B_{b1}, B_{b2}, U_{B1}, U_{B2}, V_{B1}, V_{B2} in the B quantum circuit 12 are respectively expressed as:

$${B}_{b 1} = Ph ( π ) \cdot {R}_{z} ( - \frac{π}{2} ) \cdot {R}_{y} ( 1.15909 π ) \cdot {R}_{z} ( \frac{π}{2} ) ;$$

$${B}_{b 2} = P h ( π ) \cdot {R}_{z} ( - \frac{π}{2} ) \cdot {R}_{y} ( - 0.15909 π ) \cdot {R}_{z} ( - \frac{3 π}{2} ) ;$$

$${U}_{B 1} = P h ( π ) \cdot {R}_{z} ( - \frac{3 π}{2} ) \cdot {R}_{y} ( - \frac{π}{2} ) \cdot {R}_{z} ( - 1.84088 π ) ;$$

$${U}_{B 2} = P h ( π ) \cdot {R}_{z} ( - \frac{3 π}{2} ) \cdot {R}_{y} ( - \frac{π}{2} ) \cdot {R}_{z} ( - \frac{π}{2} ) ;$$

$${V}_{B 1} = P h ( - 0.12552 π ) \cdot {R}_{z} ( - \frac{3 π}{2} ) \cdot {R}_{y} ( - \frac{π}{2} ) \cdot {R}_{z} ( - \frac{3 π}{2} ) ;$$

$${V}_{B 2} = P h ( - 0.874471 π ) \cdot {R}_{z} ( - 1.24894 π ) \cdot {R}_{y} ( - \frac{3 π}{2} ) \cdot {R}_{z} ( - \frac{π}{2} ) ,$$

and B_{b1}, B_{b2}, U_{B1}, U_{B2}, V_{B1}, V_{B2} in the B quantum circuit 12 may each be implemented by the basic 1-bit logic gates as illustrated in FIG. 4I to FIG. 4N. In the present embodiment, in each of input values (variables) of functions of the aforementioned basic 1-bit logic gates, each of the coefficients of π is expressed by five digits after decimal point under the situation in which the coefficients of π are irrational numbers, but the present disclosure is not limited thereto. In other words, the precision of these coefficients of π is adjustable as long as the quantum circuit with enough accuracy can be achieved. For example, under the situation in which five digits after decimal point of these coefficients of π have met the requirement, the sixth digit after decimal point of these coefficients of π may be regarded as any one of 0 to 9, and each of the other digits after decimal point of these coefficients of π is any one of 0 to 9. By the aforementioned method, the quantum circuit for Daubechies-6 (D6) wavelet transform may be implemented by decreasing the dimension to obtain the quantum circuit with much higher resolutions, thereby meeting the requirement of high information complexity in the current information field (particularly, the aspects of image processing and signal processing).

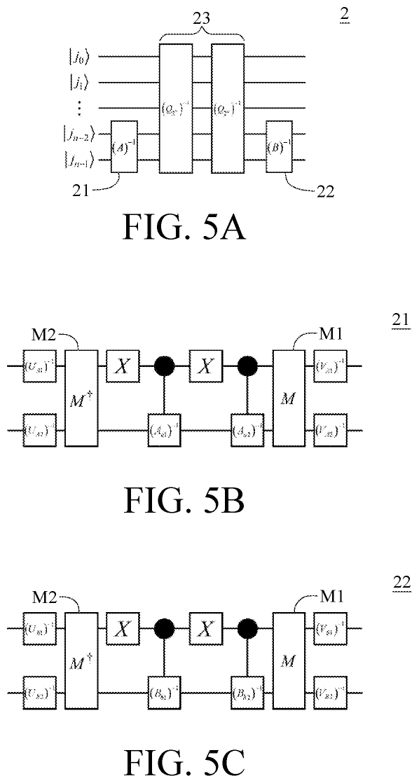

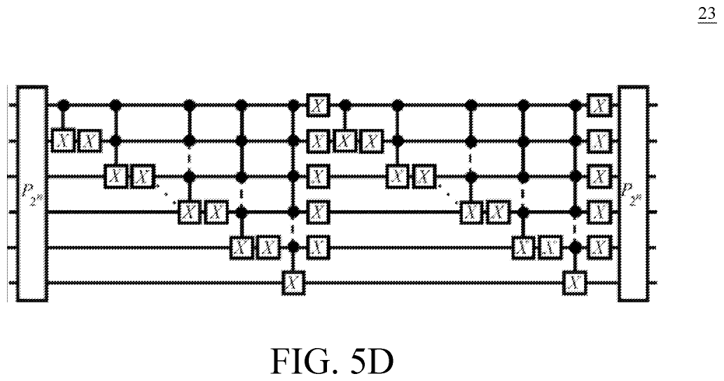

In another embodiment of the present disclosure, the quantum circuit 2 for Daubechies-6 (D6) wavelet inverse transform is further implemented and the quantum circuit 2 for Daubechies-6 (D6) wavelet inverse transform and the quantum circuit 1 for Daubechies-6 (D6) wavelet transform are paired. In the present embodiment, an inverse matrix (D₂_{ⁿ}⁽⁶)⁻¹ of the Daubechies-6 (D6) wavelet matrix D₂_{ⁿ}⁽⁶⁾ may be decomposed into (I₂_{^{n−2}}⊗(B)⁻¹) (Q₂_{ⁿ})⁻¹·(Q₂_{ⁿ})⁻¹·(I₂_{^{n−2}}⊗(A)⁻¹) and the quantum circuit 2 for Daubechies-6 (D6) wavelet inverse transform in the present embodiment may be illustrated in FIG. 5A. In this quantum circuit, the inverse matrix (A)⁻¹ of the parameter matrix A may be expressed as ((V_{A1})⁻¹⊗(V_{A2})⁻¹)·M·((Aₐ₁)⁻¹⊕(Aₐ₂)⁻¹)·M^{†}·((U_{A1})⁻¹⊗(U_{A2})⁻¹), and a (A)⁻¹ quantum circuit 21 implementing the inverse matrix (A)⁻¹ is illustrated in FIG. 5B; similarly, the inverse matrix (B)⁻¹ of the parameter matrix B may be expressed as ((V_{B1})⁻¹⊗(V_{B2})⁻¹)·M·((B_{b1})⁻¹⊕(B_{b2})⁻¹)·M^{†}·((U_{B1})⁻¹⊗(U_{B2})⁻¹), and a (B)⁻¹ quantum circuit 22 implementing the inverse matrix (B)⁻¹ is illustrated in FIG. 5C; an (Q₂_{ⁿ})⁻¹·(Q₂_{ⁿ})⁻¹ quantum circuit 23 implementing the dot product (i.e., (Q₂_{ⁿ})⁻¹·(Q₂_{ⁿ})⁻¹) of the inverse matrix (Q₂_{ⁿ})⁻¹ of the unitary matrix Q₂_{ⁿ} and the inverse matrix (Q₂_{ⁿ})⁻¹ of the unitary matrix Q₂_{ⁿ} is illustrated in FIG. 5D.

Please refer to FIG. 5A, in contrast to the aforementioned quantum circuit 1 for Daubechies-6 (D6) wavelet transform, in the quantum circuit 2 for Daubechies-6 (D6) wavelet inverse transform in the present embodiment, the (A)⁻¹ quantum circuit 21 is coupled to one side of the (Q₂_{ⁿ})⁻¹·(Q₂_{ⁿ})⁻¹ quantum circuit 23 and the (B)⁻¹ quantum circuit 22 is coupled to the other side of the (Q₂_{ⁿ})⁻¹·(Q₂_{ⁿ})⁻¹ quantum circuit 23. In operation, the quantum circuit 2 for Daubechies-6 (D6) wavelet inverse transform of this embodiment is configured to receive n-dimensional data, wherein each dimension includes a 2×1 vector. In the aforementioned received n-dimensional data, the data of the 1st dimension to the data of the (n−2)th dimension (it may correspond to j₀ as illustrated in FIG. 5A to jₙ₋₃ not illustrated in FIG. 5A) are input to the (Q₂_{ⁿ})⁻¹·(Q₂_{ⁿ})⁻¹ quantum circuit 23, and after the data of the (n−1)th dimension and the data of the nth dimension (it may correspond to jₙ₋₂ and as illustrated in FIG. 5A) are input to the (A)⁻¹ quantum circuit 21, the operation result of the (A)⁻¹ quantum circuit 21 is input to the (Q₂_{ⁿ})⁻¹·(Q₂_{ⁿ})⁻¹ quantum circuit 23. Afterwards, the first operation result to the (n−2)th operation result generated by the (Q₂_{ⁿ})⁻¹·(Q₂_{ⁿ})⁻¹ quantum circuit 23 serve as one part of output of the quantum circuit 2 for Daubechies-6 (D6) wavelet inverse transform; and the (n−1)th operation result to the nth operation result generated by the (Q₂_{ⁿ})⁻¹·(Q₂_{ⁿ})⁻¹ quantum circuit 23 are input to the (B)⁻¹ quantum circuit 22, and the operation result generated by the (B)⁻¹ quantum circuit 22 serves as the other part of output of the quantum circuit 1 for Daubechies-6 (D6) wavelet transform. Besides, U_{A1}, U_{A2}, Aₐ₁, Aₐ₂, V_{A1}, V_{A2}, U_{B1}, U_{B2}, B_{b1}, B_{b2}, V_{B1}, and V_{B2} may be referred to obtain inverse matrixes (U_{A1})⁻¹, (U_{A2})⁻¹, (Aₐ₁)⁻¹, (Aₐ₂)⁻¹, (V_{A1})⁻¹, (V_{A2})⁻¹, (U_{B1})⁻¹, (U_{B2})⁻¹, (B_{b1})⁻¹, (B_{b2})⁻¹, (V_{B1})⁻¹ and (V_{B2})⁻¹ of the U_{A1}, U_{A2}, Aₐ₁, Aₐ₂, V_{A1}, V_{A2}, U_{B1}, U_{B2}, B_{b1}, B_{b2}, V_{B1} and V_{B2} , and they are understandable.

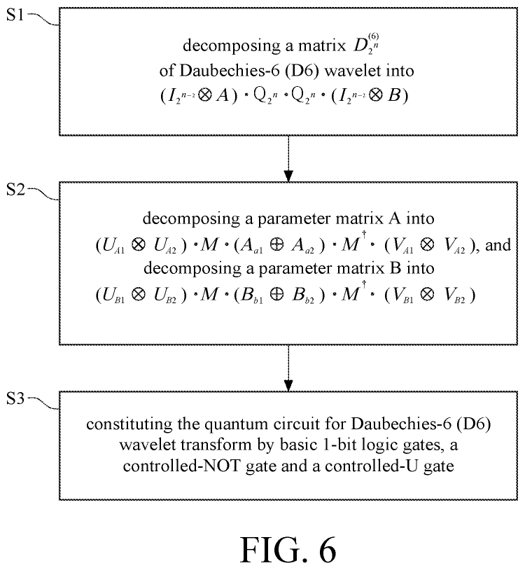

Please refer to FIG. 6, in order to generate the aforementioned quantum circuit 1 for Daubechies-6 (D6) wavelet transform, the following steps may be performed by a computing device in collaboration with logic gate processing to implement a manufacturing method of the quantum circuit 1 for Daubechies-6 (D6) wavelet transform. In step S1, a matrix D₂_{ⁿ}⁽⁶⁾ of Daubechies-6 (D6) wavelet transform is decomposed into (I₂_{^{n−2}}⊗A) Q₂_{ⁿ}·Q₂_{ⁿ}·(I₂_{^{n−2}}⊕B); in step S2, the parameter matrix A is decomposed into (U_{A}⊗U_{A2})·M·(Aₐ₁⊕Aₐ₂)·M^{†}·(V_{A1}⊗V_{A2}) and the parameter matrix B is decomposed into (U_{B1}⊗U_{B2})·M·(B_{b1}⊕B_{b2})·M^{†}·(V_{B1}⊗V_{B2}); finally, in step S3, the quantum circuit 1 for Daubechies-6 (D6) wavelet transform is constituted by the basic 1-bit logic gates, the controlled-NOT gate and the controlled-U gate based on the aforementioned (I₂_{^{n−2}}⊗A)·Q₂_{ⁿ}·Q₂_{ⁿ}·(I₂_{^{n−2}}⊗B), (U_{A1}⊗U_{A2})·M·(Aₐ₁⊕Aₐ₂)·M^{†}·(V_{A1}⊗V_{A2}) and (U_{B1}⊗U_{B2})·M·(B_{b1}⊕B_{b2})·M^{†}·(V_{B1}⊗V_{B2}). The basic 1-bit logic gates may include the Hadamard gate, the Pauli-X gate, the Pauli-Z gate, the Rotation-Y gate, the Rotation-Z gate and the Phase-Shift gates.

By utilizing the aforementioned parameter matrix A and the parameter matrix B to simplify the matrix D₂_{ⁿ}⁽⁶⁾ and the inverse matrix (D₂_{ⁿ}⁽⁶⁾)⁻¹ of Daubechies-6 (D6) wavelet transform for obtaining the quantum circuit for Daubechies-6 (D6) wavelet transform, the quantum circuit for Daubechies-6 (D6) wavelet transform may be merely implemented by the basic 1-bit logic gates, the controlled-NOT gate and the controlled-U gate. Moreover, the quantum circuit for Daubechies-6 (D6) wavelet transform/inverse transform may be further applied to the related fields about handling the high information complexity (particularly, aspects of image processing and signal processing) and the entire volume of the circuit is reduced to overcome the problem that the number of transistors in the conventional silicon chip computer daily increases.

What is claimed is:

1. A quantum circuit for Daubechies-6 (D6) wavelet transform comprising:
a B quantum circuit configured to receive a first part of n-dimensional data and generate a first intermediate result, wherein the first part comprises data of (n−1)th dimension and data of nth dimension of the n-dimensional data;
a Q₂_{ⁿ}·Q₂_{ⁿ} quantum circuit configured to receive a second part of the n-dimensional data, the Q₂_{ⁿ}·Q₂_{ⁿ} quantum circuit coupled to the B quantum circuit to receive the first intermediate result, and the Q₂_{ⁿ}·Q₂_{ⁿ} quantum circuit generating a second intermediate result corresponding to the first intermediate result and a first result corresponding to the second part, wherein the second part comprises data of 1st dimension to data of (n−2)th dimension of the n-dimensional data; and
an A quantum circuit coupled to the Q₂_{ⁿ}·Q₂_{ⁿ} quantum circuit to receive the second intermediate result and to generate a second result according to the second intermediate result;
wherein the B quantum circuit and the A quantum circuit are configured to implement two 4×4 parameter matrixes, the Q₂_{ⁿ}·Q₂_{ⁿ} quantum circuit is configured to implement a dot product of the two same 2ⁿ×2ⁿ unitary matrixes configured to transfer a state amplitude, the n is positive integer and a set of the first result and the second result serves an output of the quantum circuit for Daubechies-6 (D6) wavelet transform.

2. The quantum circuit for Daubechies-6 (D6) wavelet transform according to claim 1, wherein the A quantum circuit implement (U_{A1}⊗U_{A2})·M·(Aₐ₁⊕Aₐ₂)·M^{†}·(V_{A1}⊗V_{A2}), and the B quantum circuit implement (U_{B1}⊗U_{B2})·M·(B_{b1}⊕B_{b2})·M^{†}·(V_{B1}⊗V_{B2}) the Aₐ₁ is
$${R}_{z} ( \frac{π}{2} ) \cdot {R}_{y} ( 1.15909 π ) \cdot {R}_{z} ( - \frac{π}{2} ) ,$$
the Aₐ₂ is
$$Ph ( π ) \cdot {R}_{z} ( \frac{π}{2} ) \cdot {R}_{y} ( - 0.15909 π ) \cdot {R}_{z} ( \frac{3 π}{2} ) ,$$
the U_{A1} is
$$P h ( - 0.28355 π ) \cdot {R}_{z} ( - \frac{3 π}{2} ) \cdot {R}_{y} ( - \frac{3 π}{2} ) \cdot {R}_{z} ( \frac{3 π}{2} ) ,$$
the U_{A2} is
$$P h ( - 0.71644 π ) \cdot {R}_{z} ( - \frac{3 π}{2} ) \cdot {R}_{y} ( - \frac{3 π}{2} ) \cdot {R}_{z} ( - 1.93289 π ) ,$$
the V_{A1} is
$$P h ( - \frac{π}{2} ) \cdot {R}_{z} ( - 1.15912 π ) \cdot {R}_{y} ( - \frac{π}{2} ) \cdot {R}_{z} ( - \frac{3 π}{2} ) ,$$
the V_{A2} is
$$Ph ( - \frac{π}{2} ) \cdot {R}_{z} ( - \frac{3 π}{2} ) \cdot {R}_{y} ( - \frac{π}{2} ) \cdot {R}_{z} ( - \frac{3 π}{2} ) ,$$
the B_{b1} is
$$P h ( π ) \cdot {R}_{z} ( - \frac{π}{2} ) \cdot {R}_{y} ( 1.15909 π ) \cdot {R}_{z} ( \frac{π}{2} ) ,$$
the B_{b2} is
$$Ph ( π ) \cdot {R}_{z} ( - \frac{π}{2} ) \cdot {R}_{y} ( - 0.15909 π ) \cdot {R}_{z} ( - \frac{3 π}{2} ) ,$$
the U_{B1} is
$$P h ( π ) \cdot {R}_{z} ( - \frac{3 π}{2} ) \cdot {R}_{y} ( - \frac{π}{2} ) \cdot {R}_{z} ( - 1.84088 π ) ,$$
the U_{B2} is
$$Ph ( π ) \cdot {R}_{z} ( - \frac{3 π}{2} ) \cdot {R}_{y} ( - \frac{π}{2} ) \cdot {R}_{z} ( - \frac{π}{2} ) ,$$
the V_{B1} is
$$P h ( - 0.12552 π ) \cdot {R}_{z} ( - \frac{3 π}{2} ) \cdot {R}_{y} ( - \frac{π}{2} ) \cdot {R}_{z} ( - \frac{3 π}{2} ) ,$$
the V_{B2} is
$$P h ( - 0.874471 π ) \cdot {R}_{z} ( - 1.24894 π ) \cdot {R}_{y} ( - \frac{3 π}{2} ) \cdot {R}_{z} ( - \frac{π}{2} ) ,$$
a matrix form of the M is
$$\frac{1}{\sqrt{2}} [ \begin{matrix}1 & 0 & 0 & i \\ 0 & i & 1 & 0 \\ 0 & i & - 1 & 0 \\ 1 & 0 & 0 & - i\end{matrix} ] ,$$
a matrix form of the M^{†} is a conjugate transpose matrix of the maatrix form of the M, the 2ⁿ×2ⁿ unitary matris is
$$[ \begin{matrix}0 & 1 & 0 & 0 & … & 0 \\ 0 & 0 & 1 & 0 & … & 0 \\ 0 & 0 & 0 & 1 & … & 0 \\ ⋮ & ⋮ & ⋮ & ⋮ & ⋱ & 0 \\ 0 & 0 & 0 & 0 & … & 1 \\ 0 & 0 & 0 & 0 & … & 0\end{matrix} ] .$$

3. A quantum circuit for Daubechies-6 (D6) wavelet inverse transform comprising:
a (A)⁻¹ quantum circuit configured to receive a first part of n-dimensional data and generate a first intermediate result, wherein the first part comprises data of (n−1)th dimension and data of nth dimension of the n-dimensional data;
a (Q₂_{ⁿ})⁻¹·(Q₂_{ⁿ})⁻¹ quantum circuit configured to receive a second part of the n-dimensional data, the (Q₂_{ⁿ})⁻¹·(Q₂_{ⁿ})⁻¹ quantum circuit coupled to the (A)⁻¹ quantum circuit to receive the first intermediate result, and the (Q₂_{ⁿ})⁻¹·(Q₂_{ⁿ})⁻¹ quantum circuit generating a second intermediate result corresponding to the first intermediate result and a first result corresponding to the second part, wherein the second part comprises data of 1st dimension to data of (n−2)th dimension of the n-dimensional data; and
a (B)⁻¹ quantum circuit coupled to the (Q₂_{ⁿ})⁻¹·(Q₂_{ⁿ})⁻¹ quantum circuit to receive the second intermediate result and to generate a second result according to the second intermediate result;
wherein the (A)⁻¹ quantum circuit and the (B)⁻¹ quantum circuit are configured to implement inverse matrixes of two 4×4 parameter matrixes, the (Q₂_{ⁿ})⁻¹·(Q₂_{ⁿ})⁻¹ quantum circuit is configured to implement a dot product of inverse matrixes of the two same 2ⁿ×2ⁿ unitary matrixes and the two same 2ⁿ×2ⁿ unitary matrixes configured to transfer a state amplitude, the n is positive integer and a set of the first result and the second result serves an output of the quantum circuit for Daubechies-6 (D6) wavelet inverse transform.

4. The quantum circuit for Daubechies-6 (D6) wavelet inverse transform according to claim 3, wherein the (A)⁻¹ quantum circuit achieves ((V_{A1})⁻¹⊗(V_{A2})⁻¹)·M ·((Aₐ₁)⁻¹⊕(Aₐ₂)⁻¹)·M^{†}·((U_{A1})⁻¹⊗(U_{A2})⁻¹), the (B)⁻¹ quantum circuit achieves ((V_{B1})⁻¹⊗(V_{B2})⁻¹)·M·((B_{b1})⁻¹⊕(B_{b2})⁻¹)·M^{†}·((U_{B1})⁻¹⊗(U_{B2})⁻¹), the Aₐ₁ is
$$P h ( π ) \cdot {R}_{z} ( \frac{π}{2} ) \cdot {R}_{y} ( 1.15909 π ) \cdot {R}_{z} ( - \frac{π}{2} ) ,$$
the Aₐ₂ is
$$Ph ( π ) \cdot {R}_{z} ( \frac{π}{2} ) \cdot {R}_{y} ( - 0.15909 π ) \cdot {R}_{z} ( \frac{3 π}{2} ) ,$$
the U_{A1} is
$$P h ( - 0.28355 π ) \cdot {R}_{z} ( - \frac{3 π}{2} ) \cdot {R}_{y} ( - \frac{3 π}{2} ) \cdot {R}_{z} ( \frac{3 π}{2} ) ,$$
the U_{A2} is
$$P h ( - 0.71644 π ) \cdot {R}_{z} ( - \frac{3 π}{2} ) \cdot {R}_{y} ( - \frac{3 π}{2} ) \cdot {R}_{z} ( - 1.93289 π ) ,$$
the V_{A1} is
$$Ph ( - \frac{π}{2} ) \cdot {R}_{z} ( - 1.15912 π ) \cdot {R}_{y} ( - \frac{π}{2} ) \cdot {R}_{z} ( - \frac{3 π}{2} ) ,$$
the V_{A2} is
$$Ph ( - \frac{π}{2} ) \cdot {R}_{z} ( - \frac{3 π}{2} ) \cdot {R}_{y} ( - \frac{π}{2} ) \cdot {R}_{z} ( - \frac{3 π}{2} ) ,$$
the B_{b1} is
$$P h ( π ) \cdot {R}_{z} ( - \frac{π}{2} ) \cdot {R}_{y} ( 1.15909 π ) \cdot {R}_{z} ( \frac{π}{2} ) ,$$
the B_{b2} is
$$Ph ( π ) \cdot {R}_{z} ( - \frac{π}{2} ) \cdot {R}_{y} ( - 0.15909 π ) \cdot {R}_{z} ( - \frac{3 π}{2} ) ,$$
the U_{B1} is
$$Ph ( π ) \cdot {R}_{z} ( - \frac{3 π}{2} ) \cdot {R}_{y} ( - \frac{π}{2} ) \cdot {R}_{z} ( - 1.84088 π ) ,$$
the U_{B2} is
$$Ph ( π ) \cdot {R}_{z} ( - \frac{3 π}{2} ) \cdot {R}_{y} ( - \frac{π}{2} ) \cdot {R}_{z} ( - \frac{π}{2} ) ,$$
the V_{B1} is
$$P h ( - 0.12552 π ) \cdot {R}_{z} ( - \frac{3 π}{2} ) \cdot {R}_{y} ( - \frac{π}{2} ) \cdot {R}_{z} ( - \frac{3 π}{2} ) ,$$
the V_{B2} is Ph(−0.874471π).
$${R}_{z} ( - 1.24894 π ) \cdot {R}_{y} ( - \frac{3 π}{2} ) \cdot {R}_{z} ( - \frac{π}{2} ) ,$$
a matrix form of the M is
$$\frac{1}{\sqrt{2}} [ \begin{matrix}1 & 0 & 0 & i \\ 0 & i & 1 & 0 \\ 0 & i & - 1 & 0 \\ 1 & 0 & 0 & - i\end{matrix} ] ,$$
a matrix form of the M^{†} is a comjugate transpose matrix of the matrix form of the M, the b 2ⁿ×2ⁿ unitary matrix is
$$[ \begin{matrix}0 & 1 & 0 & 0 & … & 0 \\ 0 & 0 & 1 & 0 & … & 0 \\ 0 & 0 & 0 & 1 & … & 0 \\ ⋮ & ⋮ & ⋮ & ⋮ & ⋱ & 0 \\ 0 & 0 & 0 & 0 & … & 1 \\ 0 & 0 & 0 & 0 & … & 0\end{matrix} ] .$$

5. A manufacturing method of a quantum circuit for Daubechies-6 (D6) wavelet transform comprising:
decomposing a matrix D₂_{ⁿ}⁽⁶⁾ of Daubechies-6 (D6) wavelet into (I₂_{^{n−2}}⊗A)·Q₂_{ⁿ}·Q₂_{ⁿ}·(I₂_{^{n−2}}⊗B);
decomposing a parameter matrix A into (U_{A1}⊗U_{A2})·M·(Aₐ₁⊕Aₐ₂)·M^{†}·(V_{A1}⊗V_{A2}), and decomposing a parameter matrix B into (U_{B1}⊗U_{B2})·M·(B_{b1}⊕B_{b2})·M^{†}·(V_{B1}⊗V_{B2}); and
constituting the quantum circuit for Daubechies-6 (D6) wavelet transform by a plurality of basic 1-bit logic gates, a controlled-NOT gate and a controlled-U gate based on (I₂_{^{n−2}}⊗A)·Q₂_{ⁿ}·Q₂_{ⁿ}·(I₂_{^{n−2}}⊗B), (U_{A1}⊗U_{A2})·M·(Aₐ₁⊕Aₐ₂)·M^{†}·(V_{A1}⊗V_{A2}) and (U_{B1}⊗U_{B2})·M·(B_{b1}⊕B_{b2})·M^{†}·(V_{B1}⊗V_{B2}),
wherein the Q₂_{ⁿ} is a 2ⁿ×2ⁿ unitary matrix configured to transfer a state amplitude, the M is
$$\frac{1}{\sqrt{2}} [ \begin{matrix}1 & 0 & 0 & i \\ 0 & i & 1 & 0 \\ 0 & i & - 1 & 0 \\ 1 & 0 & 0 & - i\end{matrix} ] ,$$
the M^{†} is a conjugate transpose matrix of the M, the Aₐ₁ is
$$P h ( π ) \cdot {R}_{z} ( \frac{π}{2} ) \cdot {R}_{y} ( 1.15909 π ) \cdot {R}_{z} ( - \frac{π}{2} ) ,$$
the Aₐ₂ is
$$Ph ( π ) \cdot {R}_{z} ( \frac{π}{2} ) \cdot {R}_{y} ( - 0.15909 π ) \cdot {R}_{z} ( \frac{3 π}{2} ) ,$$
he U_{A1} is
$$P h ( - 0.28355 π ) \cdot {R}_{z} ( - \frac{3 π}{2} ) \cdot {R}_{y} ( - \frac{3 π}{2} ) \cdot {R}_{z} ( \frac{3 π}{2} ) ,$$
the U_{A2} is
$$P h ( - 0.71644 π ) \cdot {R}_{z} ( - \frac{3 π}{2} ) \cdot {R}_{y} ( - \frac{3 π}{2} ) \cdot {R}_{z} ( - 1.93289 π ) ,$$
the V_{A1} is
$$P h ( - \frac{π}{2} ) \cdot {R}_{z} ( - 1.15912 π ) \cdot {R}_{y} ( - \frac{π}{2} ) \cdot {R}_{z} ( - \frac{3 π}{2} ) ,$$
the V_{A2} is
$$Ph ( - \frac{π}{2} ) \cdot {R}_{z} ( - \frac{3 π}{2} ) \cdot {R}_{y} ( - \frac{π}{2} ) \cdot {R}_{z} ( - \frac{3 π}{2} ) ,$$
the B_{b1} is
$$P h ( π ) \cdot {R}_{z} ( - \frac{π}{2} ) \cdot {R}_{y} ( 1.15909 π ) \cdot {R}_{z} ( \frac{π}{2} ) ,$$
the B_{b2} is
$$Ph ( π ) \cdot {R}_{z} ( - \frac{π}{2} ) \cdot {R}_{y} ( - 0.15909 π ) \cdot {R}_{z} ( - \frac{3 π}{2} ) ,$$
the U_{B1} is
$$Ph ( π ) \cdot {R}_{z} ( - \frac{3 π}{2} ) \cdot {R}_{y} ( - \frac{π}{2} ) \cdot {R}_{z} ( - 1.84088 π ) ,$$
the U_{B2} is
$$Ph ( π ) \cdot {R}_{z} ( - \frac{3 π}{2} ) \cdot {R}_{y} ( - \frac{π}{2} ) \cdot {R}_{z} ( - \frac{π}{2} ) ,$$
the V_{B1} is
$$P h ( - 0.12552 π ) \cdot {R}_{z} ( - \frac{3 π}{2} ) \cdot {R}_{y} ( - \frac{π}{2} ) \cdot {R}_{z} ( - \frac{3 π}{2} ) ,$$
the V_{B2} is
$$P h ( - 0.874471 π ) \cdot {R}_{z} ( - 1.24894 π ) \cdot {R}_{y} ( - \frac{3 π}{2} ) \cdot {R}_{z} ( - \frac{π}{2} ) .$$

6. The manufacturing method of the quantum circuit for Daubechies-6 (D6) wavelet transform according to claim 5, wherein the 2ⁿ×2ⁿ unitary matrix is
$$[ \begin{matrix}0 & 1 & 0 & 0 & … & 0 \\ 0 & 0 & 1 & 0 & … & 0 \\ 0 & 0 & 0 & 1 & … & 0 \\ ⋮ & ⋮ & ⋮ & ⋮ & ⋱ & 0 \\ 0 & 0 & 0 & 0 & … & 1 \\ 0 & 0 & 0 & 0 & … & 0\end{matrix} ] .$$
